(19) United States
(12) Patent Application Publication
(10) Pub. No.: US 2015/0266149 A1
(43) Pub. Date: Sep. 24, 2015

(54) MACHINE TOOL

(71) Applicant: MITSUBISHI HEAVY INDUSTRIES, LTD., Tokyo (JP)

(72) Inventors: Yohei KOMATSU, Tokyo (JP); Keisuke YOSHIKAWA, Tokyo (JP)

(73) Assignee: MITSUBISHI HEAVY INDUSTRIES, LTD., Tokyo (JP)

(21) Appl. No.: 14/657,905

(22) Filed: Mar. 13, 2015

(30) Foreign Application Priority Data
Mar. 20, 2014 (JP) 2014-057544

(51) Int. Cl. B23Q 3/155; B23Q 3/157

(52) U.S. Cl. CPC B23Q 3/15526; B23Q 3/15713

(57) ABSTRACT

A machining center includes: a main spindle to which a tool is detachably attachable; a table on which to place a workplace; a tool magazine in which multiple pots for detachably holding tools are disposed; and a tool exchanger for exchanging the tools between the pots of the tool magazine and the main spindle. The machining center includes a long tool storing apparatus configured to store a long tool with a length longer than those of the tools stored in the tool magazine, and deliver the long tool to one of the pots of the tool magazine.

### TECHNICAL FIELD

The present invent ion relates to a machine tool such as a machining center.

### BACKGROUND ART

In a machine tool such as a machining center, a tool exchanger is capable of automatically exchanging a tool attached to a main spindle with another one from various tools stored in a tool magazine. When such a machine tool employs a long tool with a length (of approximately 700 mm, for example) slightly longer than those (of approximately 500 mm, for example) of often-used tools, a tool magazine with a size large enough to store the long tool needs to be applied to the machine tool. This results in an increase in the overall size of the machine tool, and causes difficulties in securing the space for the machine tool.

Against this background, Patent Literature 1 or the like, for example, has proposed a tool exchanger which is provided with a rack-type long tool magazine for storing long tools, and which is capable of moving the long tool magazine to a position close to the main spindle to locate the long tool near the main spindle; and then attaching the long tool to a main spindle.

### CITATION LIST

### Patent Literature

{Patent Literature 1} Japanese Patent Application Publication No. 2008-023661
{Patent Literature 2} Japanese Patent Application Publication No. 2005-103650

### SUMMARY OF INVENTION

### Technical Problem

The tool exchanger for the long tools described in Patent Literature 1 or the like, however, involves a cost increase because its capabiity of using the long tools with a considerable length (of approximately 1000 mm, for example) requires a large-scale driving mechanism for moving the long tools together with the long tool magazine.

With this taken into consideration, an object of the- present invention is to provide a machine tool capable of attaching and detaching a long tool, which is slightly longer than often-used tools, to and from a main spindle in space-saving and cost-saving manners.

### Solution to Problem

For the purpose of solving the problem, the machine tool according to the present invention provides a machine tool which includes: a main spindle to which a tool is detachably attached; a table on which to place a workpiece; a tool magazine in which multiple pots for detachably holding the tools are disposed; and a tool exchanger configured to exchange the tools between the pots of the tool magazine and the main spindle. The machine tool is characterized in that the machine tool includes a long tool storing apparatus configured to store a long tool with a length longer than those of the tools stored in the tool magazine, and deliver the long tool to one of the pots of the tool magazine.

Furthermore, the machine tool according to the present invention provides the above-described machine tool characterized in that: the tool magazine is capable of moving and locating each of the pots at a tool exchange position where the tool exchanger exchanges the tool between the pot and the main spindle; and the long tool storing apparatus always holds the long tool in a way that an axial position of the long tool and an axial position of the pot located at the tool exchange position coincide with each other in a horizontal radial direction of the pot.

Moreover, the machine tool according to the present invention provides the above-described machine tool characterized in that: the tool magazine stores the tools in a way that axial directions of the tools are oriented in a horizontal direction orthogonal to an axial direction of the main spindle; and the tool exchange position for the pot of the tool magazine is a position where an axial direction of the pot is oriented parallel to the axial direction of the main spindle.

### Advantageous Effects of Invention

According to the machine tool of the present invention, the long tool storing apparatus is capable of: storing the long tool; and delivering the long tool to one of the pots of the tool magazine. For this reason, the machine tool is capable of attaching and detaching the long tool to and from the main spindle by use of the tool exchanger for attaching and detaching the tools each with a regular length to and from the main spindle. Accordingly, the machine tool is capable of attaching and detaching the long tool to and from the main spindle in space-saving and cost-saving manners.

### BRIEF DESCRIPTION OF DRAWINGS

FIG. 1 shows a plan view of a schematic configuration of a principal embodiment of a machine tool according to the present invention;

FIG. 2 shows a side view of the schematic configuration illustrated in FIG. 1; and

FIG. 3 shows an explanatory diagram of a main part of the schematic configuration viewed in a direction indicated with an arrow III in FIG. 1.

### DESCRIPTION OF EMBODIMENTS

Descriptions will be provided for an embodiment of a machine tool according to the present invention on the basis of the drawings. The present invention, however, is not limited to the embodiment which will be described on the basis of the drawings.

### Principal Embodiment

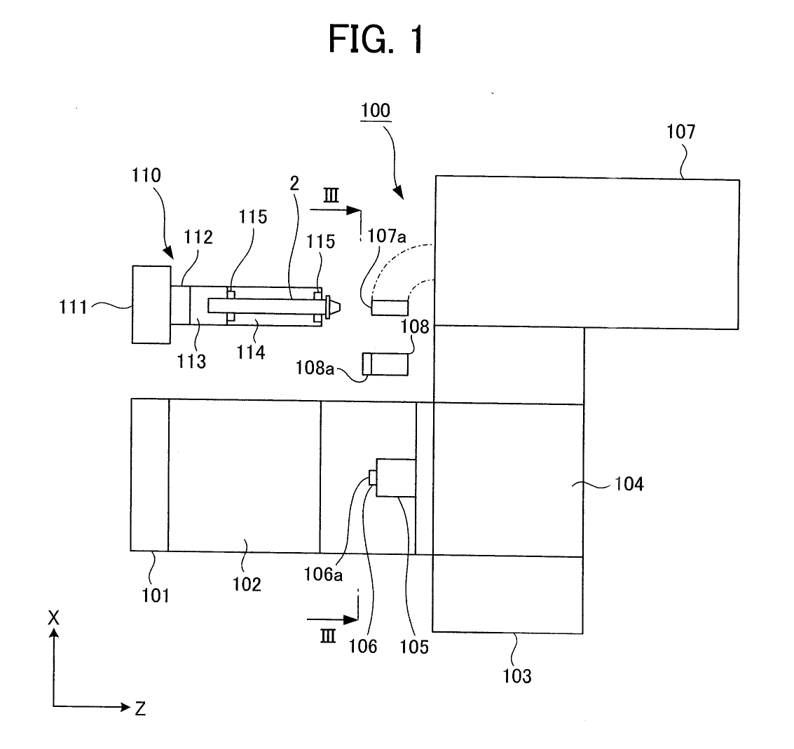

Descriptions will be provided for a principal embodiment of the machine tool according to the present invention on the basis of FIGS. 1 to 3

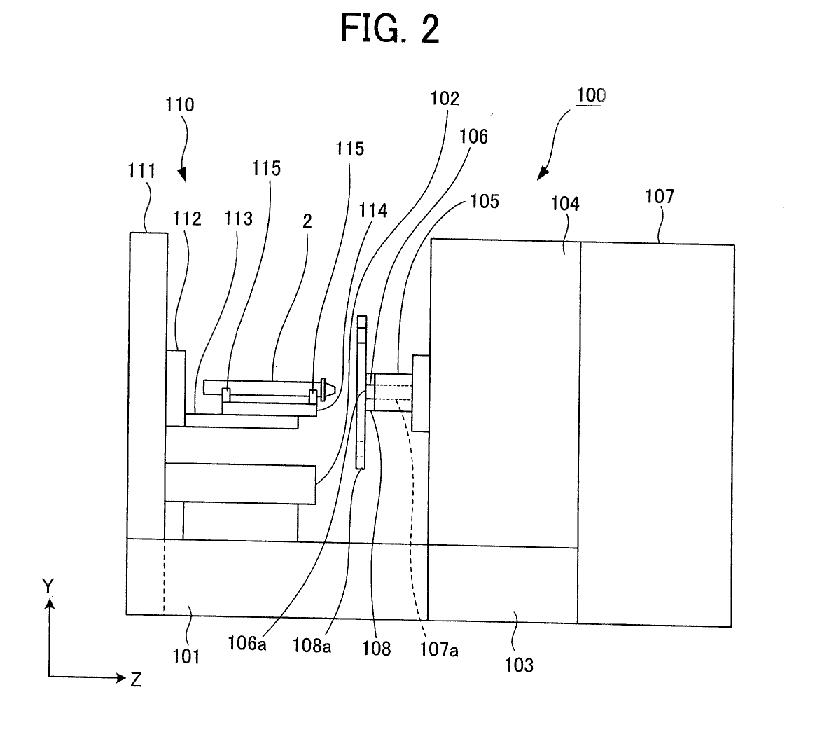

As shown in FIGS. 1 and 2, a table 102 on which to place a workpiece is disposed on a bed 101. The table 102 is designed to be movable along a top surface (guide surface) of the bed 101 (in a Z-axis direction), and turnable (on a Y axis) along a horizontal surface of the bed 101.

In addition, a column 104 is disposed on a bed 103. The column 104 is designed to be movable along a top surface (guide surface) of the bed 103 (in an X-axis direction). A main spindle head 105 is attached to a front surface of the column 104. The main spindle head 105 is designed to be movable along the front surface (guide surface) of the column 104 (in the Y-axis direction). A main spindle 106 to which to detachably attach a tool is provided to the main spindle head 105 in a way that orients the axial direction of the main spindle 106 toward the table 102 (in the Z-axis direction). Incidentally, reference sign 106a in FIGS. 1 and 2 denotes a main spindle end.

A tool magazine 107 is disposed at a side of the bed 103 (on an upper side in FIG. 1). The tool magazine 107 stores tools each with a regular length (of approximately 500 mm or thereabouts) in a way that orients their axial directions in a horizontal direction (the X-axis direction) orthogonal to the axial direction of the main spindle 106. A train of multiple pots 107a for detachably holding the tools is disposed inside the tool magazine 107. Each pot 107a is capable of moving to a designated, position inside the tool magazine 107, and turning at a predetermined area inside the tool magazine 107 to move to a tool exchange position outside the tool magazine 107, so that the axial direction of the pot 107a is oriented parallel to the axial direction of the main spindle 106 (in the Z-axis direction) (see FIG. 1) Here, the tool exchange position is a position where the pot 107a exchanges the tool with the main spindle end 106a of the main spindle 106.

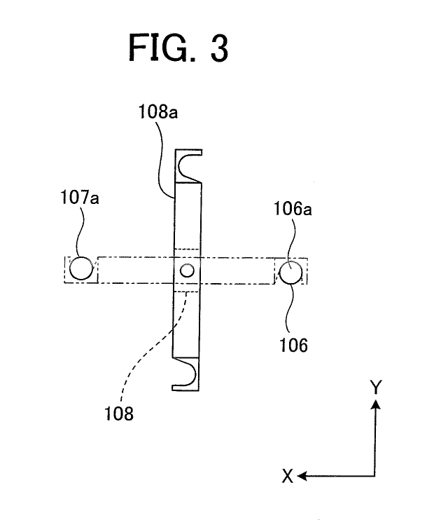

A tool exchanger 108 for exchanging the tool between the pot 107a, located at the tool exchange position outside the tool magazine 107, and the main spindle end 106a of the main spindle 106 is disposed on a tool magazine 107 side of the bed 101 near the bed 103. As shown in FIG. 3, the tool exchanger 108 is capable of turning an arm 108a in order to switch the position of the arm 108a between a standby position (indicated with solid lines in FIG. 3) and a work position (indicated with double-dashed chain lines in FIG. 3).

A long tool storing apparatus 110 is disposed in front of (in FIGS. 1 and 2, to the left of) the pot 107a located in the area of the bed 101 which is at the side of the tool magazine 107, namely at the tool exchange position outside the tool magazine 107. The long tool storing apparatus 110 is designed to store a long tool 2 with a length (of approximately 700 mm or thereabouts, for example) which is slightly longer than the regular length (of approximately 500 mm or thereabouts), and to deliver be longer tool 2 to the not 107a The long cool storing apparatus 10 has a following configuration.

As shown in FIGS. 1and 2, aside column 111 is provided upright in front of the pot 107a which is located at the tool exchange position outside the tool magazine 107. A guide surface of the side column 111, which faces to the tool magazine 107 (to the right in FIGS. 1 and 2), is provided with a movable carriage 112 capable of ascending and descending along the guide surface. A support table 113 whose longitudinal direction is oriented toward the tool magazine 107 is attached to a part of the movable carriage 112 which faces to the tool magazine 107. An upper guide surface of support table 113 is provided with a slidable table 114 capable of providing sliding movement in the axial direction of the main spindle 106 (in the left-right direction (the Z-axis direction) in FIGS. 1 and 2) along the guide surface of the support table 113. A holder 115 for detachably holding the long tool 2 in a way that the axis of the long tool 2 is oriented in the axial direction of the main spindle 106 is attached to the top of the slidable table 114.

To put it concretely, the long tool storing apparatus 110 is designed to always hold the long tool 2 in a way that the axial position of the long tool 2 and the axial position of the pot 107a located at the tool exchange position outside of the tool magazine 107 coincide with each other in a horizontal radial direction of the pot 107a. In other words, the long tool storing apparatus 110 always holds the long tool 2 in a way that the axial position of the long tool 2 and the axial position of the pot. 107a coincide with each other in the X-axis direction.

For the purpose of processing a workplace by use of a tool with the regular length (of approximately 500 mm or thereabouts), a machining center 100, namely the machine tool of the embodiment like this, works as follows. Inside the tool magazine 107, the machining center 100 moves the pot 107e holding a target tool to the predetermined position. Thereafter, the machining center 100 turns the pot 107a in order to locate the pot 107a at the tool exchange position outside the tool magazine 107. Subsequently, the machining center 100 positions the target tool in a way that the axial direction of the tool is oriented parallel to the axial direction of the main spindle 106 (in the Z-axis direction). Meanwhile, in order to locate the main spindle 106 at the predetermined position (the tool exchange position) near the tool magazine 107 (on the upper side in FIG. 1), the machining center 100 moves the column 104 in the X-axis direction along the guide surface of the bed 103, and moves the main spindle head 105 in the Y-axis direction along the guide surface of the column 104.

Afterward, the machining center 100 turns the arm 108a of the tool exchanger 108 (at 90 degrees) in order to switch the position of the arm 108a from the standby position to the work position. Then, the machining center 100 delivers the tool, which is held by the of 107a located at the tool exchange position, to one end of the arm 108a. Thereafter, the machining center 100 further turns the arm 108a (at 180 degrees) in order to locate the one end of the arm 108a at the side of the main spindle 106. Subsequently, the machining center 100 delivers and attaches the tool, which is held by the one end of the arm 108a, to the main spindle end 106a of the main spindle 106. Afterward, the machining center 100 turns the arm 108a (at 90 degrees) in order to return the arm 108a to the standby position, and turns the pot 107a, which is located at the tool exchange position, in order to return the pot 107a to the inside of the tool magazine 107.

Then, the workpiece is placed on the table 102. Thereafter, while rotating the main spindle 106, the machining center 100 processes the workpiece using the tool with the regular length by moving the workpiece and the tool three-dimensionally relative to each other through: moving the table 102 in the Z-axis direction and turning the table 102 on the Y axis; moving the column 104 in the X-axis direction; and moving the main spindle head 105 in the Y-axis direction.

For the purpose of for example, continuing to process the workpiece using the long tool 2 this time after processing the workpiece using the tool with the regular length, the machining center 100 works as follows. Inside the tool magazine 107, the machining center 100 moves a beforehand-prepared empty pot 107a to the predetermined position. Thereafter, in the same manner as described above, the machining center 100 turns the pot 107a in order to locate the pot 107a at the tool exchange position outside the tool magazine 107.

Subsequently, the machining center 100 elevates the movable carriage 112, which is located at lower standby position, along the guide surface of the side column 111 in order that the axis of the long tool 2 held by the holder 115 of the long tool storing apparatus 110 and the axial position of the empty pot 107a located at the tool exchange position outside the tool magazine 107 can coincide with each other in the Y-axis direction. Thereafter, in order to insert abase end-side portion of the long tool 2 into the pot 107a located at the tool exchange position, the machining center 100 moves forward the slidable table 114 located at the standby position by sliding the slidable table 114 in the Z-axis direction along the guide surface of the support table 113. Thereby, the machining center 100 delivers the long tool 2 to the pot 107a. Once completing the delivery, the machining center 100 moves the movable carriage 112 down and retreats the slidable table 114 in order to return the movable carriage 112 and the slidable table 114 to their respective original standby positions.

Next, in order to locate the main spindle 106 at the predetermined position (the tool exchange position) near the tool magazine 107 (on the upper side in FIG. 1), the machining center 100 moves the column 104 in the X-axis direction along the guide surface of the bed 103, and moves the main spindle head 105 in the Y-axis direction along the guide surface of the column 104. Subsequently, the machining center 100 turns the arm 108a of the tool exchanger 108 (at 90 degrees) in order to switch the position of the arm 103a from the standby position to the work position. Thereby, the machining center 100 delivers the long tool 2, which is held by the pot 107a, to the one end of the arm 108a, and concurrently delivers the tool with the regular length, which is attached to the main spindle 106, to the other end of the arm 108a. Once completing the deliveries, the machining center 100 further turns the arm 108a (at 180 degrees) in order to locate the one end of the arm 108a at the side of the main spindle 106, and the other end of the arm 108a at the side of the pot 107a. Thereby, the machining center 100 delivers and attaches the long tool 2, which is held by the one end of the arm 108a, to the main spindle end 106a of the main spindle 106, and concurrently delivers the tool with the regular length, which is held by the other end of the arm 108a, to the not 107a. Once completing the deliveries, the machining center 100 turns the arm 108a (at 90 degrees) in order to return the arm 108a to the standby position, and turns the pot 107a in order to return the pot 107a to the inside of the tool magazine 107.

Then, while rotating the main spindle 106 again, the machining center 100 resumes processing the workpiece using the long tool 2 by resuming moving the workpiece and the tool three-dimensionally relative to each other through: moving the table 102 in the Z-axis direction and turning the table 102 on the Y axis; moving the column 104 on the X-axis direction; and moving the main spindle head 105 in the Y-axis direction.

Once, for example, completing the entire process of the workpiece after processing the workpiece by use of the long tool 2, the machining center 100 works as follows, in the same manner as described above. Inside the tool magazine 107, the machining center 100 moves an empty pot 107a to the predetermined position. Thereafter, the machining center 100 turns the pot 107a in order to locate the pot 107a at the tool exchange position outside the tool magazine 107. Meanwhile, in order to locates the main spindle 106 at the predetermined position (the tool exchange position) near the tool magazine 107 (on the upper side in FIG. 1), the machining center 100 moves the column 104 in the X-axis direction along the guide surface of the bed 103, and moves the main spindle head 105 in the Y-axis direction along the guide surface of the column 104.

Subsequently, the machining center 100 turns the arm 108a of the tool exchanger 108 (at 90 degrees) in order to switch the position of the arm 108a from the standby position to the work position. Thereby, the machining center 100 delivers the long tool 2, which is attached to the main spindle 106, to the one end of the arm 108a. On completing the delivery, the machining center 100 further turns the arm 108a (at 180 degrees) in order to locate the one end of the arm. 108a at the side of the pot 107a. Thereby, the machining center 100 delivers the long tool 2, which is held by the one end of the arm 108a, to the pot 107a. Thereafter, the machining center 100 turns the arm 108a at 90 degrees) in order to return the arm 108a to the standby position.

Then, in order to place the long tool 2, which is held by the pot 107a located at the tool exchange position, onto the holder 115 of the long tool storing apparatus 110, the machining center 100 elevates the movable carriage 112, which is located at the lower standby position, along the guide surface of the side column 111, and moves forward the slidable table 114 located at the standby position by sliding the slidable table 114 in the direction along the guide surface of the support table 113. Thereby, the machining center 100 delivers the long tool 2 from the pot 107a to the holder 115. Once completing the delivery, in order to return the long tool 2 to the original standby position, the machining center 100 retreats the slidable table 114 by sliding the slidable table 114 in the Z-axis direction along, the guide surface of the support table 113, and moves the movable carriage 112 down along the guide surface of the side column 111.

In short, the machining center 100 of the embodiment is designed in the way that the long tool storing apparatus 110 stores the long tool 2, and delivers the long tool 2 to the pot 107a of the tool magazine 107.

For this reason, the machining center 100 of the embodiment is capable of attaching and detaching the long tool 2 to and from the main spindle 106 by use of the tool exchanger 108 for attaching and detaching tools each with the regular length to and from the main spindle 106. This makes it possible to omit a driving mechanism for attaching and detaching only the long tool 2 to the main spindle 106.

Accordingly, the machining center 100 of the embodiment is capable of attaching and detaching the long tool 2 to and from the main spindle 106 in space-saving and cost-saving manners.

Furthermore, the long tool storing apparatus 110 always holds the long tool 2 in the way that: the axial position of the long tool 2 and the axial position of the pot 107a located at the tool exchange position coincide with each other in the horizontal radial direction of the pot 107a. In other words, the long tool storing apparatus 110 always holds the long tool 2 in the way that the axial, position of the long tool 2 and the axial position of the pot 107a coincide with each other in the X-axis direction. For this reason, the long tool storing apparatus 110 no longer need be provided with a driving mechanism for moving the long tool 2 in the X-axis direction. Accordingly, the configuration of the long tool storing apparatus 110 can be more simplified by completely omitting the driving mechanism for moving the long tool 21n the X-axis direction, which would be otherwise the largest among the driving mechanisms for the long tool 2. This makes it possible to further enhance the space-saving and cost-saving benefits.

Meanwhile, the tool magazine 107 for storing the tools in the way that the axial directions of the tools are oriented in the horizontal direction (the X-axis direction) orthogonal to the axial direction of the main spindle 106 is disposed at the side of the bed 103 (on the upper side in FIG. 1). Furthermore, each pot 107a is designed to be located at the tool exchange position by turning the pot 107a in the way that the axial direction of the pot 107a are oriented in the direction parallel to the axial direction of the main spindle 106 (in the Z-axel direction). In other words, the tool exchange position for the pot 107a is designed as the position in which the axial direction of the pot 107a is oriented in the direction parallel to the axis of the main spindle 106. For these reasons, the long tool storing apparatus 110 can be disposed without increasing the size (the opening) of the machining center 100 in the X axis direction (the widthwise direction.) In other words, the long tool storing apparatus 110 can be disposed by using a dead space. This makes it possible to set up the machining center 100 in a space whose size is equal to that required for a conventional machining center.

### Other Embodiment

The foregoing descriptions have been provided for the embodiment using the long tool storing apparatus 110 which includes the holder 115 attached to the top of the slidable table 114, and which is designed to be capable of detachably holding the one long tool 2 only. It should be noted, however, that another embodiment which enables multiple long tools 2 to be selectively used can be carried out, for example, by applying a long tool storing apparatus in which: a rack capable of storing the multiple long tools 2 in the vertical direction (the Y-axis direction) is provided to the top of the slidable table 114; and a target long tool can be delivered to the pot 107a, located at the tool exchange position, by elevating and lowering the movable carriage 112 along the guide surface of the side column 111.

The machine tool according to the present invention can be used very beneficially in the field of the metal working industry because of'its capability of attaching and detaching the long tool to and from the main spindle in the space-saving and cost-saving mariners.

### REFERENCE SIGNS LIST

2 long tool

100 machining center

101 bed

102 table

103 bed

104 column

105 main spindle head

106 main spindle

106a main spindle end

107 tool magazine

107a pot

108 tool exchanger

108a arm

110 long tool storing apparatus

111 side column

112 movable carriage

113 support table

114 slidable table

115 holder

1. A machine tool comprising:
a main spindle to which a tool is detachably attachable;
a table on which to place a workplace;
a tool magazine in which a plurality of pots for detachably holding tools are disposed;
a tool exchanger configured to exchange the tools between the pots of the tool magazine and the main spindle; and
a long tool storing apparatus configured to store a long tool with a length longer than those of the tools stored in the tool magazine, and deliver the long tool to one of the pots of the tool magazine.

2. The machine tool according to claim 1, wherein
the tool magazine is capable of moving and locating each of the pots at a tool exchange position where the tool exchanger exchanges the tool between the pot and the main spindle, and
the long tool storing apparatus always holds the long tool in a way that an axial position of the long tool and an axial position of the pot located at the tool exchange position coincide with each other in a horizontal radial direction of the pot.

3. The machine tool according to claim 2, wherein
the tool magazine stores the tools in a way that axial directions of the tools are oriented in a horizontal direction orthogonal to an axial direction of the main spindle, and
the tool exchange position for the pot of the tool magazine is a position where an axial direction of the pot is oriented parallel to the axial direction of the main spindle.
